(19) United States
(12) Patent Application Publication
(10) Pub. No.: US 2008/0046324 A1
(43) Pub. Date: Feb. 21, 2008

(54) TELEPHONE APPARATUS AND ADVERTISING METHOD USING TELEPHONE APPARATUS

(76) Inventors: Derek Wayne Bailey, Philadelphia, PA (US); Alexandra Bailey, Philadelphia, PA (US)

Correspondence Address: DOVAS LAW P.C., 307 BAINBRIDGE STREET, PHILADELPHIA, PA, 19147, US

(21) Appl. No.: 11/839,452

(22) Filed: Aug. 15, 2007

Related U.S. Application Data
(60) Provisional application No. 60/822,643, filed on Aug. 17, 2006.

(51) Int. Cl. G06Q 30/00; G06F 17/30

(52) U.S. Cl. 705/14

(57) ABSTRACT

A method for advertising is provided. The method includes providing a user with an IP telephone device and providing phone service to the user through an IP network. A user profile is obtained from the user of the IP telephone device, and advertisements and advertiser user profile preferences are obtained from a plurality of advertisers. Based on a comparison of the user profile with the advertiser user profile preferences, advertisements are transmitted through the IP network to the IP telephone device, and the advertisements are delivered with the IP telephone device to the user. The phone service is subsidized based on an amount of the advertisements delivered by the IP telephone device. A system for advertising including an IP telephone device is also provided.

### CROSS REFERENCE TO RELATED APPLICATION(S)

This application claims the benefit of U.S. provisional application No. 60/822,643, filed Aug. 17, 2006, which is incorporated by reference as if fully set forth.

### BACKGROUND

For years, small and mid-size firms, advertisers, and marketing consultants have invested time and effort in developing various methods for reaching, communicating with and influencing the purchasing decisions of specific groups of consumers. Each advertising initiative is focused on influencing customer decisions, either through apparent or subtle means. Advertisers have advertised using direct mailings, newspapers, fliers, magazines, radio, television, and banners, just to name a few, and have also uses various public relations methods, goodwill gestures, coupons, incentives and other means to influence customer decision and to build relationships with consumers. Unfortunately, while a healthy variety of advertising methods exists, advertisers face a lack of methods by which they may effectively deliver advertising content, goodwill gesturers and coupon offers to “specific consumers” in a timely and cost effective manner.

The primary obstacle to any advertising or public relations campaign is the expense. Further, mass media only reaches large groups of consumers in an indirect manner. For instance, the gross cost of advertising via radio can be about $23 per thousand impressions, calculated using a combined metro and rural advertising rate. One impression is a single person looking at one advertisement one time. If the same person views or hears the advertisement multiple times, for instance, once while driving to work and once while returning home from work, that person's multiple perceptions of the ad constitute multiple impressions. The expense of advertising via television, newspaper, and direct mail is often cost prohibitive. As a result, a need exists for a method of advertising products and services to consumers that is less expensive, on a per consumer basis, than any of these conventional advertising methods but equally, if not more, effective. In addition, a need exists for a method of advertising that is “specific” in its reach and therefore makes an impression on “exactly” the right consumer.

While advertisers have used conventional to advertise their goods, services and other items for many years, conventional methods have realized mixed results at best. One cause of the often poor results is that each of these methods passively engages the consumer; the engagement is random and for a very limited duration, typically only a few seconds. For instance, advertisers using conventional advertising methods such as radio, television, magazines, newspapers, flyers, internet and the like simply place advertisements on medium having some likelihood of being seen or heard by the targeted consumers for three to sixty seconds.

While advertisers desire that each one of their advertisements be placed in front of consumers, conventional advertising mechanisms do not typically result in such an outcome. For instance, not all advertisements placed in a newspaper are seen by consumers because most consumers do not look at every page of a newspaper. Instead, consumers often only glance at the front page of a couple of sections of the newspaper. As a result, advertisements included on inside pages of such newspapers do not result in an impression.

Advertisers generally agree that the quality of the impression (the duration of time it is viewed) is a very important component in impression advertising. For example, it is generally accepted that consumers need up to 5 minutes of exposure to a message, assuming the message contains the key buying information, to make a purchase decision. Since most of the conventional advertising methods deliver only seconds of exposure, many more exposures are required for effective message saturation. Accordingly, more money must be spent on mediums to reach the impression values required to help consumers reach a decision.

As explained above, conventional methods of passive advertising do not result in an impression being made from each advertisement, often result in very poor percentages of impressions made per advertisement, and fail to provide an impression of more than a few seconds resulting in an impression which lacks quality. Thus, a need exists for a method of advertising that increases the number of impressions made per advertisement and increases the impression quality (duration) of each advertisement.

The biggest problem for most advertisers is budget waste inherent in mass advertising. Most small and mid-size businesses have a primary customer base that numbers in the 10s to 100s. Few have thousands of customers. Most operate in a limited service area, yet each must purchase advertising based on reaching thousands or even millions of people using conventional advertising methods in hopes that the consumers in their much smaller client base will see the message and respond to it. The expense of this approach reduces profits and returns on investment and eliminates many smaller firms from the advertising market. Thus, a need exists for a method of advertising that creates a communication path between advertisers and consumers which allows advertisers to reach specific, demographically profiled, consumers, within specific geographic areas, with specific messages and/or offers, thus eliminating advertising budget waste.

Advertising has not been the only method by which small and mid-size firms, advertisers, marketing consultants and others have attempted to influence the purchasing habits of consumers. Each has also attempted to increase sales by offering sales incentives, such as coupons. Coupons can include offers for mail-in rebates, redemptions, and savings at the point of sale. Coupons have historically been distributed to consumers through direct mailings, newspapers, magazines, printed on the back side of cash register receipts, and dispensed from dispensers located on shelving within an aisle of a store. Internet merchants distribute coupons through web ads and email. Coupons have rarely been distributed to consumers in a targeted manner. Rather, coupons are usually distributed to consumers in a mass format with the hope that some of the coupons will reach an interested consumer in a timely manner. In addition, coupons distributed in this manner typically are never viewed by the intended consumer. The intended consumer may not have picked up the paper, he or she may not have logged onto the Web or the direct mail may be sitting on a table for days or is simply put in the garbage. As a result, coupons distributed to consumers in this fashion suffer from low redemption rates.

It is widely known within the retail industry that consumers purchase products and services based, in part, on convenience and perceived price value. It is also true that most coupons are presented at an inopportune time to consumers and can rarely be delivered to consumers in a convenient manner with a high probability of being viewed by an interested consumer. Hence, only about one percent of all coupons issued are redeemed. If a coupon is not timely or is unduly burdensome, the consumer will be less likely to redeem the coupon. If the principal driver of the consumer to purchase the product is the incentive offered on the coupon, the business or advertiser is in danger of losing the sale. Therefore, a need exists for a method for supplying a purchasing incentive to specific consumers, in a timely manner, which has a high likelihood of being viewed, and that is more convenient to redeem than methods currently used.

Public relation marketing schemes also play a huge role in the efforts of advertisers to reach and influence consumers to remember a brand name or to purchase a product or service. Often, the public relations effort takes the form of providing consumers with positive news reviews about the advertiser or giving the consumer small gifts, i.e. premiums, with the advertiser's logo or brand attached to the gift. A drawback with such public relations gestures is that consumers place very little value on premiums typically given away, i.e. cups, pens, shirts, add-on products, etc., and it is prohibitively expensive to give away items which have a significant perceived value to the consumer. Therefore, a need exists for a method for supplying a consumer premium which has a known and very high perceived value to the consumer.

In view of the above, there exists a need for an efficient, cost-effective, one-to-one connection between advertisers and targeted consumers.

### SUMMARY

The present invention provides a method for advertising. The method includes providing a user with an IP telephone device and providing phone service to the user through an IP network. A user profile is obtained from the user of the IP telephone device, and advertisements and advertiser user profile preferences are obtained from a plurality of advertisers. Based on a comparison of the user profile with the advertiser user profile preferences, advertisements are transmitted through the IP network to the IP telephone device, and the advertisements are delivered with the IP telephone device to the user. The phone service is subsidized based on an amount of the advertisements delivered by the IP telephone device.

The present invention further provides a system for advertising. The system includes an IP telephone device and an advertiser server configured for delivering advertisements to the IP telephone device and receiving advertisements from advertiser systems. The advertiser server is configured for connection to the IP telephone device and the plurality of advertiser systems through an IP Network.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a plan view of an IP telephone device according to a preferred embodiment of the present invention.

FIG. 2 is a perspective view of an IP telephone device positioned on a horizontal surface in use by a user.

FIG. 3 is a diagram of a system for delivering advertisements and advertiser information to an IP telephone according to a preferred embodiment of the present invention.

FIG. 4 is a plan view of an IP telephone device of FIG. 1 showing a plurality of information category icons displayed on the screen.

FIG. 5 is a flowchart showing a method of advertising according to a preferred embodiment of the present invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

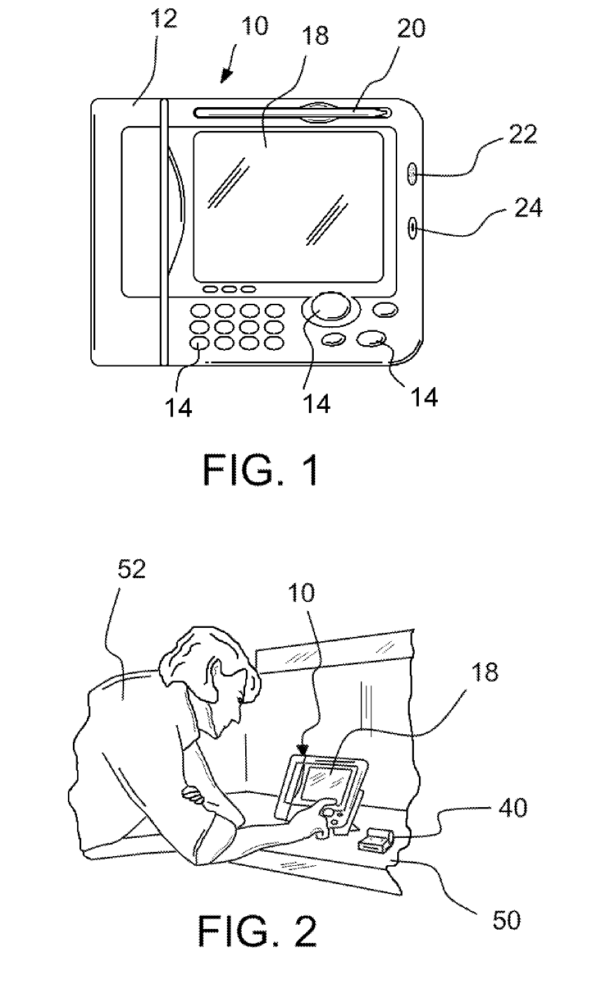

Referring to FIG. 1, an IP telephone device 10 according to a preferred embodiment of the present invention is shown. The phone device 10 includes a handset 12, a plurality of control buttons 14 for entering user inputs and a display screen 18. Preferably, the display screen 18 is a touch-screen for receiving manual user inputs directly on the surface of the display screen 18, and a stylus 20 is preferably provided for more precise on-screen user inputs such as written script. Alternatively, any suitable features can be provided for entering user inputs. Accordingly a user can in various manners interact with elements displayed on the display screen 18. Output speakers 22 and a microphone 24 are preferably provided to allow for hands-free communication using the IP telephone device 10. The IP telephone device 10 is preferably SIP based touch-screen IP telephone device and preferably includes a suitable amount of processing power and memory to allow robust web-browsing functionality. The IP telephone device 10 further includes suitable connection port(s) and/or wireless transceiver(s) for communication with an IP (Internet Protocol) network.

Referring to FIG. 2, the IP telephone device 10 is shown mounted on a horizontal surface 50 in a semi-vertical position for use by a user 52 according to a preferred embodiment of the present invention. Alternatively, the IP telephone device 10 can be wall-mounted, mounted flat on a horizontal surface, or positioned in any suitable manner. Further, the IP telephone device 10 can alternatively be sized for hand held use.

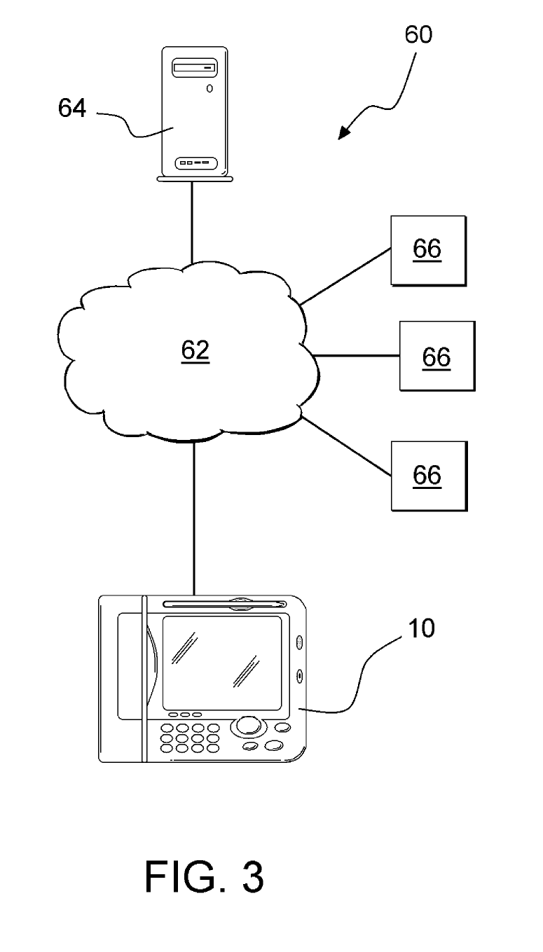

Referring to FIG. 3, shown is a system 60 for delivering advertisements and advertiser information to an IP telephone user according to a preferred embodiment of the present invention. The system 60 includes a telephone device, preferably the IP telephone device 10 of FIGS. 1 and 2, or alternatively, any suitable IP telephone device. The IP telephone device 10 and a host server 64 are preferably connected to an IP Network 62 which preferably includes the Internet. This connection can be made through any known internet connection method such as industry standard cable, DSL, wireless, dial-up or any suitable data link. The host server 64 preferably includes an advertiser server which stores a plurality of advertisements and advertiser information for delivery to the telephone device 10. Preferably, the host server 64 also stores profiles of users of a plurality of the IP telephone devices 10. These user profiles preferably include personal, geographic, and demographic information for at least some of the users.

The host server 64 is preferably capable of receiving digital transmission of advertisements including any suitable advertiser information from a plurality of advertiser systems 66 for transmission from the host server 64 to the telephone devices 10 of a plurality of users. The advertiser systems 66 preferably include any suitable internet connectable computer systems. Advertisements preferably include audio, video, interactive multimedia, or any form of advertisement suitable for delivery by a personal computer. Other advertiser information can include advertiser contact information, product and service listings, or any information descriptive of the advertiser's offerings. Alternatively, the IP telephone devices 10 and advertiser systems 66 can be connected to the host server directly without utilizing an IP Network.

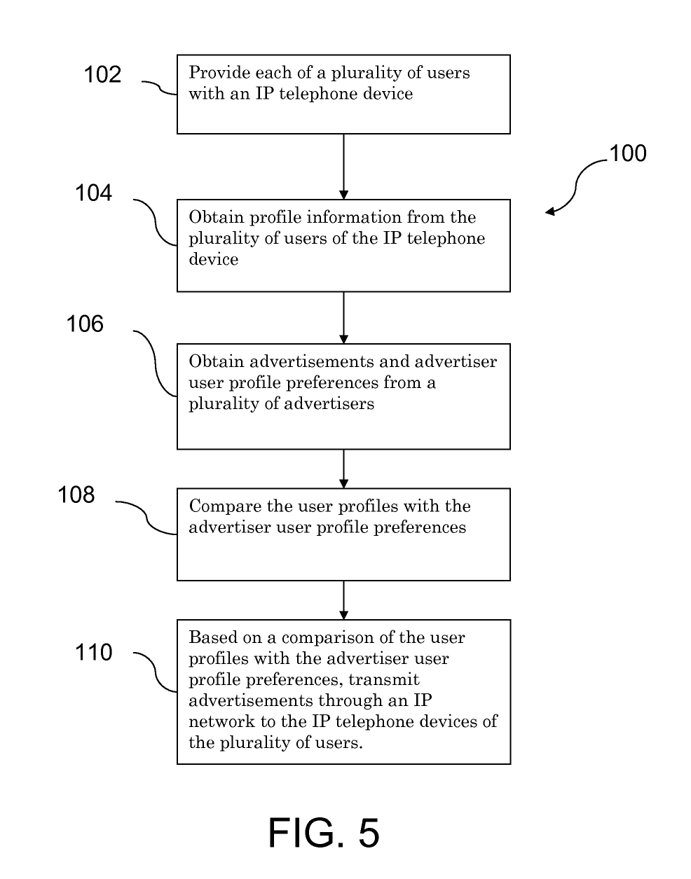

Referring to FIG. 5, a method for advertising 100 according to a preferred embodiment of the present invention is shown. The method 100 as described below refers to the IP telephone device depicted in FIGS. 1, 2 and 4 and the advertising system 62 depicted in FIG. 3. However, the method 100 is not limited to use of the IP telephone device 10 or the advertising system 60 depicted in FIG. 3. The method 100 could be used with other IP telephone devices or advertising systems.

The method 100 includes providing each of a plurality of users with an IP telephone device (step 102), for example the IP telephone device 10 of FIGS. 1-4. Preferably, the IP telephone device 10 is given to a user at reduced cost or free, the actual cost being subsidized by a plurality of advertisers. Alternatively, the IP telephone device 10 can be provided to a user only once the user has completed a user profile survey as described in step 104. Preferably, the plurality of users are provided with reduced cost or free IP telephone service to allow connection of the IP telephone device 10 to an IP Network, for example the IP Network 62 shown in FIG. 3. Users preferably include consumers who use the IP telephone device 10 in their home. Several users, for example several household members can share a single IP telephone device 10.

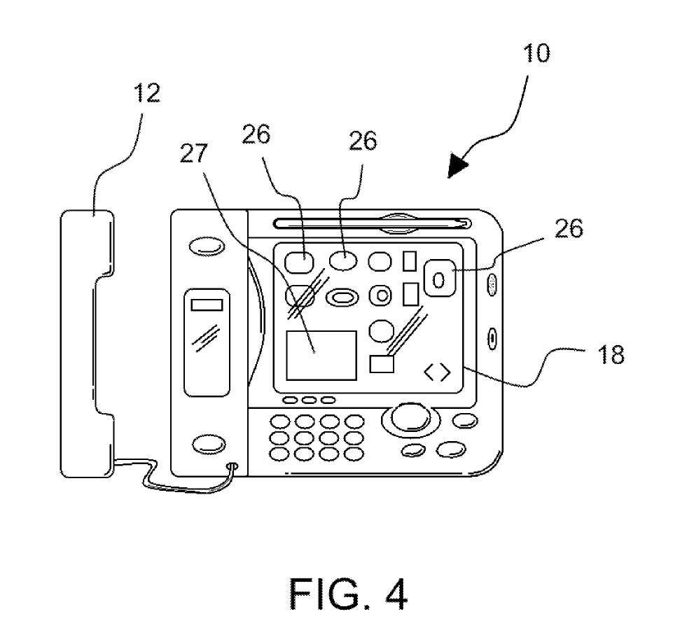

User profiles are obtained from each of the plurality of users (step 104). In the case where two or more users share a single IP telephone device 10, user profiles are preferably obtained from each of the two or more users. User profiles preferably include personal, geographic, and demographic information. More preferably, profiles specifically include one or more of a user's age, race, income, location, zip code, educational level, and specific personal preferences. Personal preference information for example can include user purchasing and dining habits, and preferred leisure activities and travel destinations. Information such as location or zip code is easily obtained from the user through typical customer intake procedures. Other information such as age, race, educational level and personal preferences are preferably obtained via a customer survey. Preferably, at least some questions in a customer survey are to be answered by a user as a condition of obtaining a free or subsidized IP telephone device 10 and/or free or subsidized local and international IP telephone service. User profiles are preferably stored on a server, for example the server 64 shown in FIG. 4. Alternatively, each user profile can be stored on the user's IP telephone device 10.

Preferably, the survey is given to a user through the IP telephone device 10 during the user's first attempt to use the IP telephone device 10 in an initialization procedure. In the initialization procedure of the IP telephone device 10, the user contacts the host server 64 using the IP telephone device 10 to receive survey queries and submit query responses. Preferably, the display screen 18, output speakers 22 and microphone 24 on the IP telephone device 10 serve as an interface for the user to input user profile information. In such case, it is preferable that the user is provided with a number of predetermined profile information choices to choose from, for example personal, geographic, and demographic choices, transmitted by the host server and displayed on the display screen 18 or emitted audibly through the speakers 22 or the handset 12. The user inputs user profile information using the IP telephone device 10, through selection of the predetermined profile information choices, or alternatively, through any suitable manner.

Preferably, the initialization procedure of the IP telephone device 10 also permits the user to select desired customized interface qualities, for example the selection and arrangement of interactive category icons 26 associated with preferred information categories for display by the display screen 18. The information regarding the customization is included with the user profile and transmitted along with survey information to the host server 64 to permit more efficient advertisement targeting. For example, an advertiser may select to have its advertisements transmitted to a user who, during interface customization, selects certain information categories associated with the advertiser's product or service to be displayed as an icon on the display screen 18.

Referring to FIG. 3, the display screen 18, which is preferably a touch screen, of the IP telephone device 10, is shown with multiple category icons 26 preferably configured by the user. For example, the icons can be associated with categories such as “Lawyers”, “Landscapers”, “Insurance agents”, “Restaurants”, etc. The category icons 26 are interactive to permit selection by a user, and the category icons 26 preferably include links to advertiser information, located on one or more of the IP telephone device 10, the host server 64 and the advertisers' websites. For example, a user may select to have a restaurant icon displayed on the display 18, the category icon 26 being linkable to advertisements, local or remote, or contact information for advertisers which provide restaurant services. Emergency, public service and government information may also be included as categories with associated icons, preferably without charge to any such listed organizations. After the initialization procedure, the category icons 26 and associated links are preferably provided along with advertisement displays 27, which are preferably also interactive and preferably include links to other advertiser-provided information, and which are displayed on the screen 18 automatically without any user input.

After the initialization procedure, including the survey and IP telephone customization, is complete, the host server activates a free or subsidized calling service for use with the IP telephone device 10. Alternatively, if a survey or other aspects of the initialization procedure is not completed by the user, calling service for the IP telephone device 10 can be provided, but with lesser or no subsidizing of the cost. Preferably, the initialization procedure of the IP telephone device 10 also permits the user to select desired interface qualities, for example a color scheme or layout displayed by the display screen, or sounds emitted by the output speakers 22.

Advertisements, for example the advertisement display 27, and advertiser user profile preferences are obtained from a plurality of advertisers (step 106), for example through the advertiser systems 66 shown in FIG. 4. Advertisers preferably complete a customer survey which describes their preferred customer profile, otherwise called their user profile preference. Advertiser user profile preferences preferably include desired personal, geographic, and demographic information of users that the advertiser wishes to target. More preferably, advertiser user profile preferences preferably include age, race, income, location, zip code, educational level, and specific personal preferences of users that the advertiser wishes to target. One or more user profile preferences and one or more associated advertisements of each of the advertisers are stored in a central server, for example the server 64 shown in FIG. 4. The advertisements are preferably one of audio, video, interactive multimedia, or any form of advertisement suitable for delivery by an IP telephone device having multimedia capabilities.

User profiles are compared with the advertiser user profile preferences (step 108). If at least one item of information from a user's profile matches at least one advertiser user profile preference, the advertiser's advertisement, for example in the advertisement display 27, is selectively transmitted to that user's IP telephone device 10 (step 110). The advertiser determines which profile preference or combination of profile preferences will trigger transmission of the advertisement. Preferably, the advertisement is transmitted from a central server, for example from the host server 64 shown in FIG. 3, to the user's IP telephone device 10. Alternatively, each advertisement can be stored on a respective advertiser's computer, for example the system 66, and transmitted directly to the user's IP telephone device 10 through the network 62. The transmission of advertisements to the user's IP telephone device 10 can occur in real-time, hourly, daily, weekly, monthly, or at any suitable predetermined time period, and is preferably determined by the host server 64.

After transmission by the host server 64, the advertisements are preferably stored in a memory of the IP telephone device 10, and preferably selectively ran by the IP telephone device 10 at a time and manner predetermined by the host server 64. Alternatively, advertisements can be delivered in real-time for example in the form of streaming audio or video in the advertisement display 27. The advertisements preferably included links, which the user can follow through the interface of the IP telephone device 10, which direct the user through the IP Network to the advertiser website or other associated data location. Moreover, automatic dialing functionality may be provided by the advertisement to connect the user directly to the advertiser via telephone. The host server 64 preferably maintains the memory of the IP telephone device 10, and in addition to updating advertisements, one or more of software, firmware, and drivers for the IP telephone device 10 can also be updated. Further, the host server 64 preferably maintains a record of the number of times a particular advertisement is delivered or displayed by the IP telephone device 10 as an impression, and/or the number of times a user follows an advertisement link, and this information can be used as the basis for billing the advertiser.

Advertisers are preferably billed per transmission or impression of advertisement on the IP telephone device 10, or alternatively, per selection by a user of advertisement(s) on the IP telephone device 10 which are linked to a website or other associated data location. Alternatively, any suitable advertiser billing method can be employed. The cost of phone calls placed by each consumer are preferably partially or completely subsidized by the number of impressions displayed while the consumer is using the IP telephone device 10, or alternatively, per selection by a user of advertisement(s) on the IP telephone device 10 which are linked to a website or other associated data location. Preferably therefore, a user which views a significant number of advertisements may receive phone service at no cost, whereas a viewer who views a lesser number of advertisements may receive phone service at a lesser cost. Alternatively, all users are provided with phone service at no cost, irrespective of the amount of advertisements displayed by the IP telephone device 10.

Preferably, in addition to standard advertisements, the host server 64 provides the IP telephone device 10 with other media and services. For example, an email service is preferably provided. Also text, audio or video advertisements in the form of searchable or non-searchable business listings can optionally be provided. Optionally, news reports and entertainment, including for example text, photo or video programming can also be provided. Further, a coupons listing can be provided, in which case a printing device provided integrally with or external to the IP telephone device 10, for example the printer 30, is preferably provided to allow a user to print selected coupons. Any provided external printer is preferably wireless, for example utilizing Bluetooth or other wireless transmission technologies.

Network links to advertiser-sponsored or free media such as internet radio and internet television are preferably provided. For example, select ones of the icons 26 can provide links to internet television or radio stations, and to their associated descriptions and program scheduling, which are accessible through the network 62. Alternatively, select ones of the icons 26 can link to menus which display a plurality of selectable media outlets including for example the internet television and radio stations. Like other services provided by the IP telephone device 10, media services are preferably accessible through user actuation of touch features on the display screen 18, or alternatively through actuation of one or more of the control buttons 14, which can function for example as a tuner to select desired media outlets. Alternatively, the IP telephone device 10 may provide unrestricted Internet access with the advertisers' advertisements displayed in proximity to portions of the display 18 used for such web surfing.

It is preferred that the IP telephone device 10 deliver media and services, substantially continuously, even when the phone is not in use. Accordingly, it is preferred that the display 18 is configured to remain continuously on and displaying advertisements and other media whenever power is supplied to the IP telephone device 10. In this manner, advertisers can gain a maximum amount of exposure for their advertisements, and the user can conveniently utilize the services provided by the host server 64.

As indicated, any suitable format of advertisement, for example audio, video, banner, or interactive multimedia, coupons can be transmitted to the IP telephone device 10 for delivery to a user. It is preferred that the advertisements which are delivered by the IP telephone device 10 be non-audio during a time period in which a call connection is made, to avoid distracting the user. It is also preferred that audio advertisements and other audio media be delivered by IP telephone device 10 only during a dialing period prior to a telephone connection and not during any period in which the phone is not in use.

An example of a preferred manner of transmission of an advertisement according to step 110 of the method 100 is as follows. A redeemable promotional coupon advertisement such as an audio, video and/or animation advertisement, is transmitted to the IP telephone device 10 for emission or display for a predetermined time period, for example 2 minutes. Alternatively, the coupon advertisement can be delivered by the IP telephone device 10 for any suitable length of time. Using any of the user input features provided by the telephone device 10, a user preferably can electronically redeem a promotion of the coupon advertisement. The advertiser system 66 is preferably notified electronically of the redemption of the promotion through the network 62. Preferably, such promotional coupon advertisements are redeemable only for a limited time. Accordingly, promotional coupon advertisements or links thereto are preferably stored in or made accessible by the IP telephone device for a limited time, for example 45 minutes to 1 day. Promotional coupon advertisements are preferably made accessible through an icon 26 displayed on the display 18 of the IP telephone 10, or alternatively, through the advertisement display 27. Preferably, the user is motivated to select the displayed coupon icon 26 by promotional coupon advertisements which are displayed upon selection of the icon 26, which offer, for example, free or reduced priced products or services. Alternatively, notification of redeemable prizes or gifts can be provided at random to the IP telephone device 10 of users who review stored coupons or select a coupon icon 26, providing a further incentive to a user to view coupons.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A method for advertising comprising:
providing a user with an IP telephone device;
providing phone service to the user through an IP network;
obtaining a user profile from the user of the IP telephone device;
obtaining advertisements and advertiser user profile preferences from a plurality of advertisers;
comparing the user profile with the advertiser user profile preferences to create a comparison;
based on the comparison of the user profile with the advertiser user profile preferences, transmitting the advertisements through the IP network to the IP telephone device of the user and delivering the advertisements with the IP telephone device to the user; and
subsidizing the phone service of the user based on an amount of the advertisements delivered by the IP telephone device.

2. The method of claim 1, further comprising subsidizing the phone service in response to a delivery of at least one advertisement with the IP telephone device.

3. The method of claim 1, further comprising:
obtaining the user profile and the advertiser user profile preferences through an IP Network;
matching the user profile to at least one of the advertiser user profile preferences; and
transmitting at least one of the advertisements corresponding to the at least one of the advertiser user profile preferences to the IP telephone device.

4. The method of claim 1, wherein the obtaining the user profile includes obtaining at least one of personal, geographic and demographic information of the user, and the method further comprises comparing the at least one of personal, geographic, and demographic information of the user with the advertiser user profile preferences to create the comparison.

5. The method of claim 1, wherein the obtaining advertiser user profile preferences includes obtaining desired user location information from the advertiser.

6. The method of claim 1, further comprising:
obtaining at least a portion of the user profile during an initialization procedure comprising providing queries to the user; and
commencing subsidizing of the phone service based on at least one of answering of the queries by the user and completion of the initialization procedure by the user.

7. The method of claim 1, further comprising:
obtaining category preferences from the user as at least a portion of the user profile; and
displaying advertisements with the IP telephone device within user-selectable categories, the user-selectable categories being defined by the user's category preferences.

8. The method of claim 1, further comprising:
displaying advertisements with the IP telephone device within user-selectable categories; and
subsidizing telephone calls made with the IP telephone device based on an amount of time the user browses the user-selectable categories.

9. The method of claim 1, further comprising:
displaying an interactive coupon dispensing advertisement display with the IP telephone device within user-selectable categories for a predetermined period of time; and
printing a coupon with the IP telephone device in response to a user interaction with the interactive coupon dispensing advertisement display.

10. The method of claim 1, wherein the obtaining of advertisements comprises obtaining at least one of company contact information, company product information, and company service information.

11. The method of claim 1, further comprising:
providing the IP telephone device with a display screen; and
displaying the advertisements on the display screen.

12. The method of claim 1, further comprising transmitting the advertisements through the IP network to the IP telephone device with link information configured to direct a user to a remote server.

13. The method of claim 1, further comprising:
providing a printer which is at least one of in communication with and integral with the IP telephone device; and
dispensing a coupon with the IP telephone device using the at least one printer in response to a user's interaction with at least one of the advertisements.

14. The method of claim 1, further comprising:
providing at least one host server;
delivering the advertisements from the host server through the IP Network to the IP telephone device;
recording, with the at least one host server, at least one of an amount of advertisement impressions and an amount of user interactions with the advertisements delivered by the IP telephone device to the user; and
billing the plurality of advertisers based on the at least one of the amount of advertisement impressions and the amount of user interactions with the advertisements delivered, as recorded by the at least one host server.

15. The method of claim 1, further comprising providing the phone service with international calling capability.

16. A system for advertising comprising:
an IP telephone device; and
at least one advertiser server configured for delivering advertisements to the IP telephone device and receiving advertisements from a plurality of advertiser systems, the advertiser server configured for connection to the IP telephone device and the plurality of advertiser systems through an IP Network.

17. The system for advertising of claim 16, wherein the IP telephone device comprises:
an interactive touch screen; and
a handset connected to the interactive touch screen.

18. The system for advertising of claim 16, wherein the at least one advertiser server includes a memory configured to record and save at least one of an amount of advertisement impressions and an amount of user interactions with the advertisements delivered by the IP telephone device to the user with the at least one advertiser server.

19. The system for advertising of claim 16, wherein the IP telephone device is configured to receive from the IP network at least one of streaming audio and streaming video.
